(19) United States
(12) Patent Application Publication
(10) Pub. No.: US 2006/0213947 A1
(43) Pub. Date: Sep. 28, 2006

(54) Tacker apparatus with an anti-double fire means at single fire mode

(75) Inventors: Cho Bo-Seob, Seoul (KR); Kim Jae-Sung, Seoul (KR); Hwang In-Sung, Incheon (KR); Kim Myung-Kyun, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: JEIL TACKER CO., LTD.

(21) Appl. No.: 11/255,837

(22) Filed: Oct. 20, 2005

(30) Foreign Application Priority Data
Mar. 22, 2005 (KR) 10-2005-23773

(51) Int. Cl. B25C 1/04

(52) U.S. Cl. 227/8; 227/130

(57) ABSTRACT

A tacker with anti-double firing means has a guide installed at the front end of a body, a cover installed at the rear end of the body and having a compressed air controlling member, a handle grip and a trigger installed at the lower end of the body, a magazine installed under the guide and filled with tacker pins, and a pushing plate installed in the trigger for pressing a valve rod for operating a piston. The anti-double firing means comprises a connector installed in the guide such that the connector moves back and forth, and having a notch formed such that the upper end of an anti-double firing plate is inserted into the notch in a single firing mode; and the anti-double firing plate separated from the pushing plate, connected to the pushing plate, and restraining the connector from moving backward due to the repulsive force of the connector.

Pursuant to 35 U.S.C. § 119(a), this application claims the benefit of earlier filing date and right of priority to Korean Patent Application No. 10-2005-0023773, filed on Mar. 22, 2005, the content of which is hereby incorporated by reference herein in its entirety.

### BACKGROUND OF THE INVENTION

1. Field of the Invention

The present invention relates to a tacker with anti-double firing means for use in a single firing mode, and more particularly to a tacker with anti-double firing means, which comprises an anti-double firing plate installed at the front end of a pushing plate so that a connector does not push the pushing plate once again due to the repulsive force of the connector caused by firing when a trigger is pulled in a single firing mode under the condition that the front end of the tacker contacts a target site of an object and is pressed against the target site and the connector moves backward, to precisely perform a single firing operation.

2. Description of the Related Art

As well known to those skilled in the art, a tacker-nailer, a stapler, and a pinner, which are used in construction and interior works, are pneumatic machines for fastening a wooden article to another wooden article, a wooden article to a plastic article, a wooden article to a steel article, or a wooden article to a concrete article, and are used in various works, such as exterior works and aluminum chassis works.

Generally, as shown in FIG. 1, a tacker comprises a body 1 having a piston and a cylinder installed therein, a cover 2 for providing air to, and eliminating air from, the piston, a magazine 3 loaded with nails, staples or pins, and a guide 4 for launching the nails, a safety device 5 for ensuring safe operation, a latch device 6 for loading the tacker with nails, a bracket 7 for connecting the magazine 3 to a handle grip 8 to obtain the firm structure of the tacker, and a trigger 9 for driving the tacker.

In the above tacker, the trigger 9 is operated to move the piston installed in the body 1, thereby allowing the nails or the staples loaded in the magazine 3 to go through a desired position of an object through the guide 4.

Most of conventional tackers further comprise all or one of continuous and single firing switches and a locking device, or do not comprise any one of them. Further, most of conventional tackers comprise or do not comprise the safety device 5. A single firing operation is performed to obtain a precision work, and a continuous firing operation is performed to increase user's convenience and efficiency. The locking device is used to prevent accidents caused by user's carelessness.

More particularly, with reference to FIGS. 2A, 2B, 2C, and 2D, single and continuous firing methods using a conventional tacker, such as a nailer, will be illustrated. A safety device 5 is provided at the front end of the tacker and is connected to a connector 100, as shown in FIG. 2A, which is installed in the guide 4. If the connector 100 does not move to the rear end of the tacker in the single or continuous firing position, nails are not launched. Thereby, the tacker prevents accidents caused by user carelessness.

In the single firing operation using the conventional tacker, the tacker has an initial position as shown in FIG. 2A. In the above position, a user puts the connector 100 of the tacker into contact with a target site of an object, and presses the tacker against the target site. Then, as shown in FIG. 2B, the connector 100 moves towards an operating member 10 (in the direction of B), and the rear end of the connector 100 moves a pushing plate 94, connected to the lower end of a trigger 92 by a connection pin 96, to the operating member 10 by a designated length.

Thereby, due to the backward movement of the pushing plate 94, the rear surface of the pushing plate 94 inserts a valve rod 12, protruded from the operating member 10, into the operating member 10, by a designated length.

Under the above state, when the user pulls the trigger 92, as shown in FIG. 2C, the lower end of the trigger 92 moves in the direction of A, centering on a rotating pin 97 fastened to the upper end of the trigger 92. Then, a rear contact plane 94b of the pushing plate 94 connected to the trigger 92 by the pin 96 completely inserts the valve rod 12 into the operating member 10. When the valve rod 12 is completely inserted into the operating member 10, tacker pins or nails loaded in the guide are launched forward.

The pushing plate 94 is connected to the lower end of the trigger 92 by the pin 96, but, under the condition that the connector 100 has not move toward the operating member 10, the pushing plate 94 cannot completely press the valve rod 12 into the operating member 10, thereby preventing the tacker pins or the nails from being launched. Therefore, when the trigger 92 is pulled under the condition that a contact point between the upper front plane 94c of the pushing plate 94 and the connector 100 is a support point, the upper end of the pushing plate 94 cannot move forward due to the contact with the connector 100, and the lower end of the pushing plate 94 moves due to the rotation of the trigger 92, and presses the valve rod 12.

In the continuous firing operation using the conventional tacker, in which a user does not fire one tacker pin but fires several tacker pins toward a broad area of an object in a short time, the user presses the front end of the tacker to a target site under the condition that the user pulls the trigger 92, thereby causing the connector 100 to move toward the operating member 10 (in the direction of B) and the tacker pins to be launched. The fundamental principle of the continuous firing operation is the same as that of the single firing operation. However, in the continuous firing operation, the connector 100 does not contact the object first, but is pressed onto the target site of the object under the condition that the trigger 92 is pulled first.

If the number of target sites of an object is three and the target sites are in close proximity, the user pulls the trigger 92 in the continuous firing mode, and presses the connector 100 against one target site of the object, thereby causing one nail to be launched toward the first target site of the object. Then, the user moves the tacker to another target site of the object under the condition that the trigger 92 is pulled, and presses the connector 100 against the target site of the object, thereby causing other nails to be continuously launched toward the second and third target sites of the object.

In the conventional tacker in the single firing mode, when the connector 100 contacts the target site and the trigger 92 is pulled, a nail is launched onto the target site and the valve rod 12 is pressed again due to the repulsive force of the connector 100 in the same manner as the continuous firing mode. When the valve rod 12 is pressed, the tacker, which should be fired once, is fired twice, thereby causing a difficulty in precisely performing the single firing mode.

### SUMMARY OF THE INVENTION

Therefore, the present invention has been made in view of the above problems, and it is an object of the present invention to provide a tacker with anti-double firing means, which comprises an anti-double firing plate installed at the front end of a pushing plate so that a connector does not push the pushing plate once again due to the repulsive force of the connector caused by firing when a trigger is pulled in a single firing mode under the condition that the front end of the tacker contacts a target site of an object and is pressed against the target site and the connector moves backward, to precisely perform a single firing operation.

In accordance with the present invention, the above and other objects can be accomplished by the provision of a tacker with anti-double firing means, the tacker which has a body, a guide installed at the front end of the body, a cover installed at the rear end of the body and provided with a member for controlling compressed air, a handle grip and a trigger installed at the lower end of the body, a magazine installed under the guide and filled with tacker pins, and a pushing plate installed in the trigger for pressing a valve rod for operating a piston, the anti-double firing means comprising: a connector installed in the guide installed at the front end of the body of the tacker such that the connector moves back and forth, and provided with a notch formed in a designated portion of the rear end thereof such that the upper end of an anti-double firing plate is inserted into the notch in a single firing mode; and the anti-double firing plate separated from the pushing plate by a designated distance, coaxially connected to the pushing plate by a connection pin, and restraining the connector from moving backward due to the repulsive force of the connector.

Preferably, a fixing spring connected to the connection pin is fixed to one side of the anti-double firing plate to cause the upper end of the anti-double firing plate to be located close to an operating member.

Further, preferably, a latched plane for preventing the connector from moving backward due to the repulsive force is formed on the front surface of the anti-double firing plate, and a rounded plane for allowing the connector to move toward the front end of the tacker is formed on the rear surface of the anti-double firing plate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a conventional tacker;

FIGS. 2A, 2B, 2C, and 2D are schematic views illustrating operations of the conventional tacker in single and continuous firing modes;

FIG. 3A is a partially detailed view of a connector of a tacker with anti-double firing means in accordance with an embodiment of the present invention;

FIGS. 3B, 3C, and 3D are transversal views illustrating the constitution and operation of the anti-double firing means in a single firing mode using the tacker with the anti-double firing means in accordance with the embodiment of the present invention; and

FIGS. 4A, 4B, 4C, and 4D are transversal views illustrating the constitution and operation of the anti-double firing means in a continuous firing mode using the tacker with the anti-double firing means in accordance with the embodiment of the present invention.

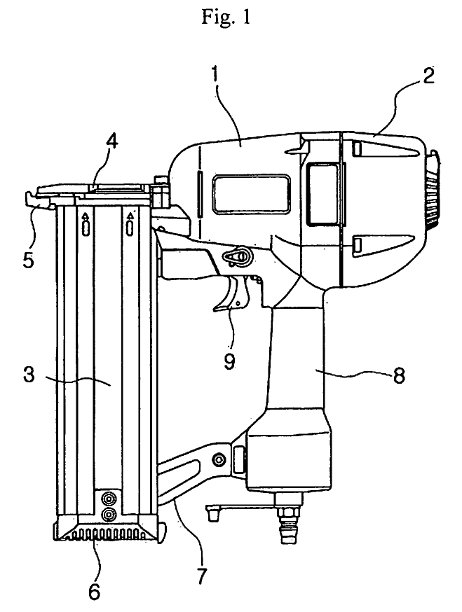

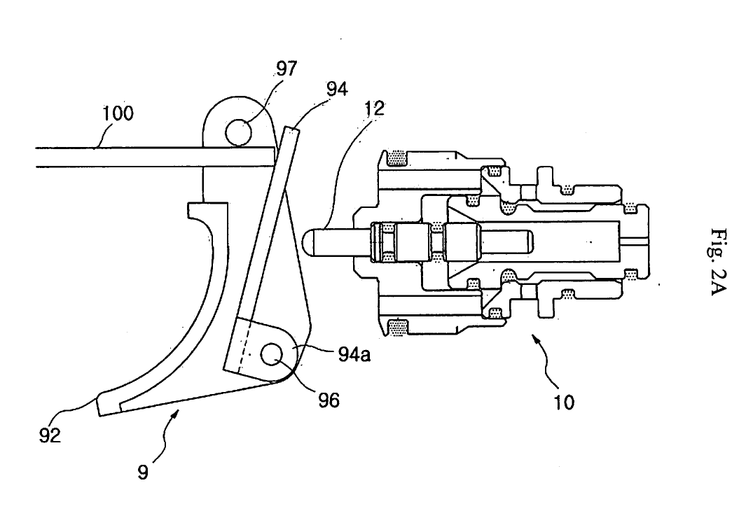

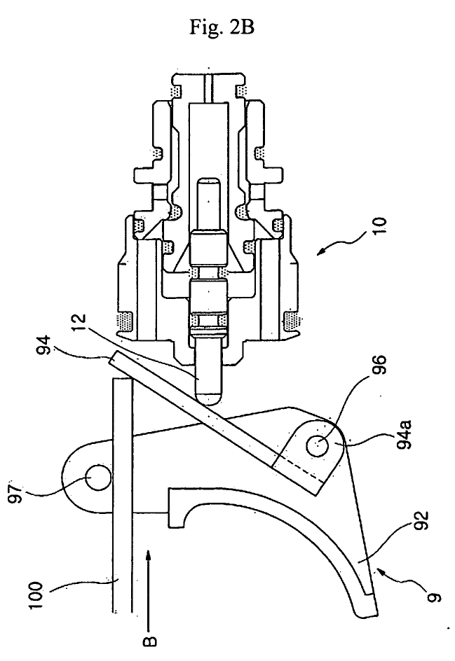

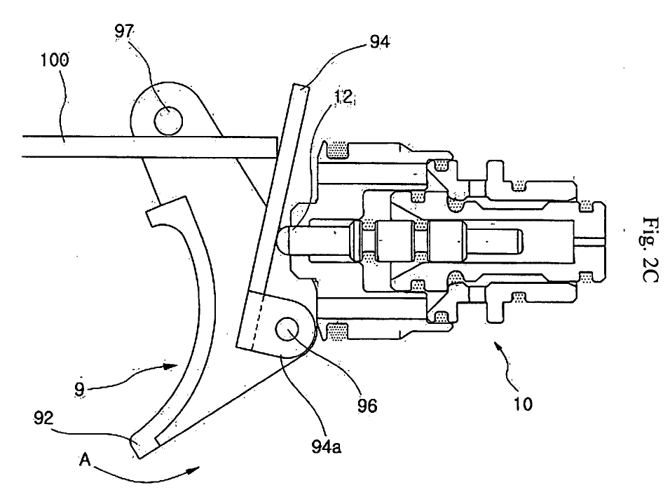

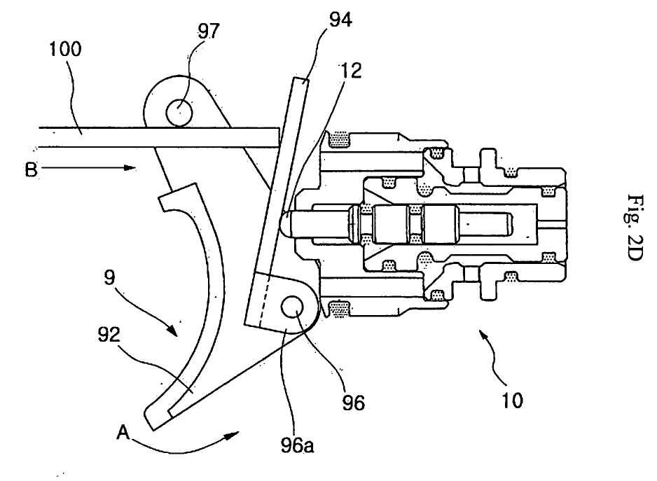

### DESCRIPTION OF THE PREFERRED EMBODIMENTS

Now, a preferred embodiment of the present invention will be described in detail with reference to the annexed drawings.

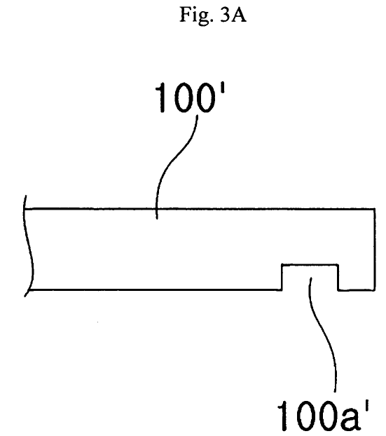

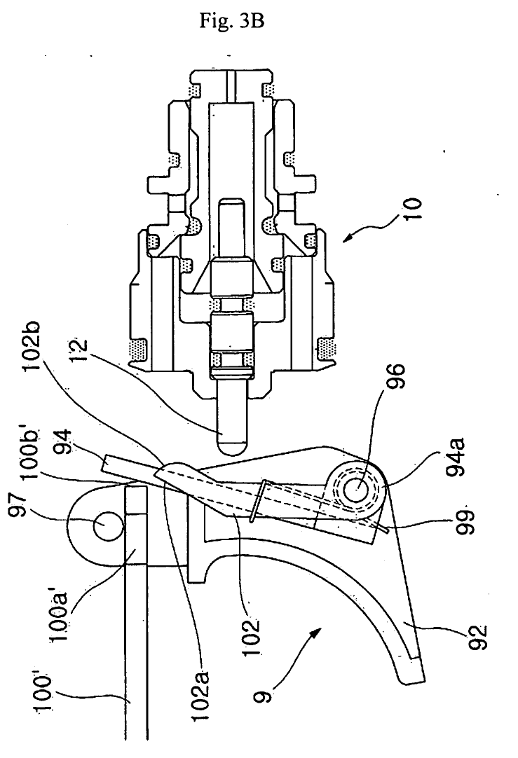

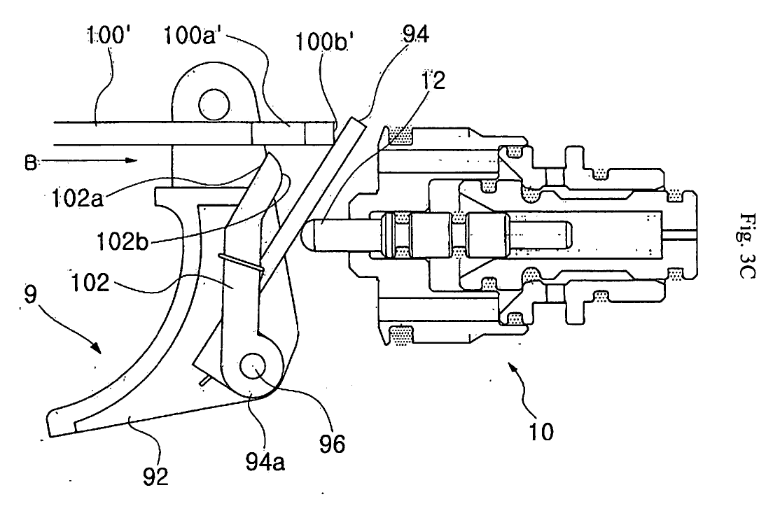

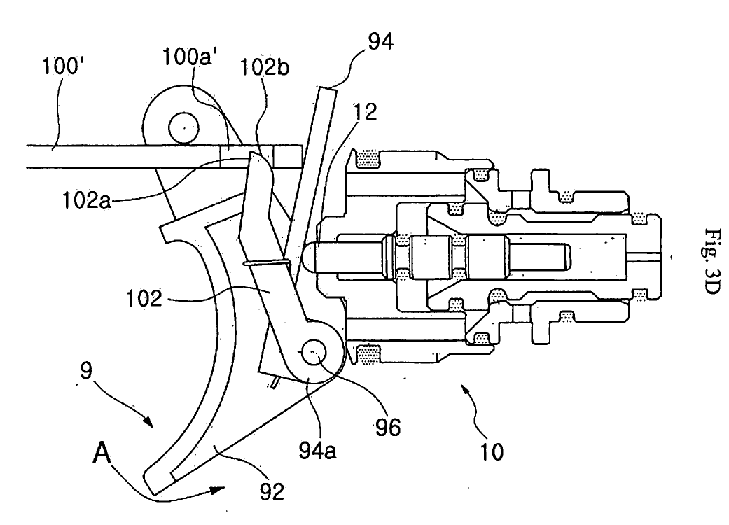

FIG. 3A is a partially detailed view of a connector of a tacker with anti-double firing means in accordance with an embodiment of the present invention. FIGS. 3B, 3C, and 3D are transversal views illustrating the constitution and operation of the anti-double firing means in a single firing mode using the tacker with the anti-double firing means in accordance with the embodiment of the present invention.

With reference to FIGS. 3A to 3D, the tacker in accordance with the embodiment of the present invention comprises an anti-double firing plate installed at the front end of a pushing plate so that a connector does not push the pushing plate once again due to the repulsive force of the connector caused by firing when a trigger is pulled under the condition that the front end of the tacker contacts a target site of an object in the single firing mode and is pressed against the target site and the connector moves backward, thereby precisely performing a single firing operation.

Since the tacker with the anti-double firing means of the present invention, which is made in view of problems of conventional tackers, must prevent continuous firing due to the repulsive force of a connector 100′ in the single firing mode, an anti-double firing plate 102, which will be described later, in the single firing mode, does not cause the anti-double firing plate 102 to disturb the movement of the connector 100′. The anti-double firing plate 102 prevents the repulsive force of the connector 100′ after the single firing motion from being transmitted to the pushing plate 94.

First, the constitution of the tacker with the anti-double firing means in accordance with the embodiment of the present invention will be described. The tacker with the anti-double firing means comprises the connector 100′ installed in the guide 4 formed at the front end thereof such that the connector 100′ can move back and forth. A notch 100a′ is formed in a designated portion of the rear end of the connector 100′ such that the upper end of the anti-double firing plate 102 is inserted into the notch 100a′ in the single firing mode.

The upper end of a trigger 92 is rotatably connected to the lower end of a body 1 by a rotation pin 97, and the pushing plate 94 is connected to the lower end of the inside of the trigger 92 by a connection pin 96.

An operating member 10 for providing compressed air through a piston (not shown), installed therein, due to the operation of the trigger 92 is provided in the rear of the trigger 92, and a valve rod 12 is protruded from the front end of the operating member 10 such that the valve rod 12 can enter into the operating member 10.

The anti-double firing plate 102, which is separated from the pushing plate 94 by a designated distance, which is coaxially connected to the pushing plate 94 by the connection pin 96, and which restrains the connector 100′ from moving backward due to the repulsive force of the connector 100′, is provided at one side of the pushing plate 94. A fixing spring 99 for fixing the anti-double firing plate 102 is fixed to the connection pin 96, thereby causing the upper end of the anti-double firing plate 102 to be constantly located at the rear end of the connector 100′.

A front latched plane 102a of the upper end of the anti-double firing plate 102 restricts the repulsive force of the connector 100′, and prevents the connector 100′ from moving backward, and a rear rounded plane 102b of the upper end of the anti-double firing plate 102 separates the notch 100a′ of the connector 100′ from the anti-double firing plate 102.

Now, the operation of the above tacker with the anti-double firing means in accordance with the embodiment of the present invention in the single firing mode will be described. In the single firing mode, the tacker is in an initial state, as shown in FIG. 3B. In the above state, a user puts the connector 100′ in contact with a target site of an object, and presses the front end of the tacker against the target site. Then, as shown in FIG. 3C, the connector 100′ moves toward the operating member 10 (in the direction of B), and the rear end of the connector 100′ moves the pushing plate 94, which is connected to the lower end of the inside of the trigger 92 by the connection pin 96, toward the operating member 10 by a designated length.

Therefore, due to the backward movement of the pushing plate 94, the rear surface of the pushing plate 94 inserts the valve rod 12, which is protruded from the operating member 10, into the operating member 10 by a designated length.

Under the above state, when the user pulls the trigger 92, as shown in FIG. 3D, the lower end of the trigger 92 moves centering on a rotating pin 97, which is fastened to the upper end of the trigger 92, in the direction of A. Then, a rear contact plane 94b of the pushing plate 94, connected to the trigger 92 by the pin 96, completely inserts the valve rod 12 into the operating member 10. When the valve rod 12 is completely inserted into the operating member 10, tacker pins or nails, which are loaded in the guide 4, are launched forward.

At this time, the upper end of the anti-double firing plate 102 is rotated centering on the rotating pin 97 in proportion to the movement distance of the trigger 92, and is inserted into the notch 100a′ formed in the connector 100′. Thereby, the anti-double firing plate 102 does not disturb the movement of the connector 100′ in the single firing mode.

Under the above condition, the firing is performed, and the connector 100′ moves forward by a designated length. When the connector 100′ moves forward, the anti-double firing plate 102 moves forward by a designated distance by the rear rounded plane 102b of the anti-double firing plate 102, inserted into the notch 100a′ of the connector 100′, and the fixing spring 99, connected to the anti-double firing plate 102, and the rounded plane 102b is separated from the notch 100a′. In this state, when the connector 100′ moves backward again due to the repulsive force caused by firing, the rear end of the connector 100′ does not move backward due to the front latched plane 102a of the anti-double firing plate 102. Thereby, since the repulsive force of the connector 100′ is not transmitted to the pushing plate 10, the connector 100′ does not press the valve rod 12, and the second firing caused by the repulsive force of the connector 100′ is not performed.

Even when the trigger 92 is pulled in the direction of A under the above state, the valve rod 12 is not pressed and the second firing is not performed. In order to perform the second firing, the user must pull the trigger 92 again in the direction of A under the condition that the connector 100′ contacts another target site of the object and the front end of the tacker is pressed against the target site.

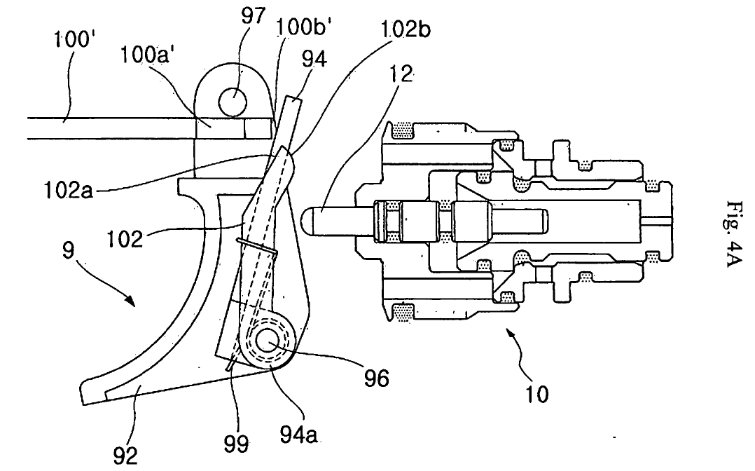

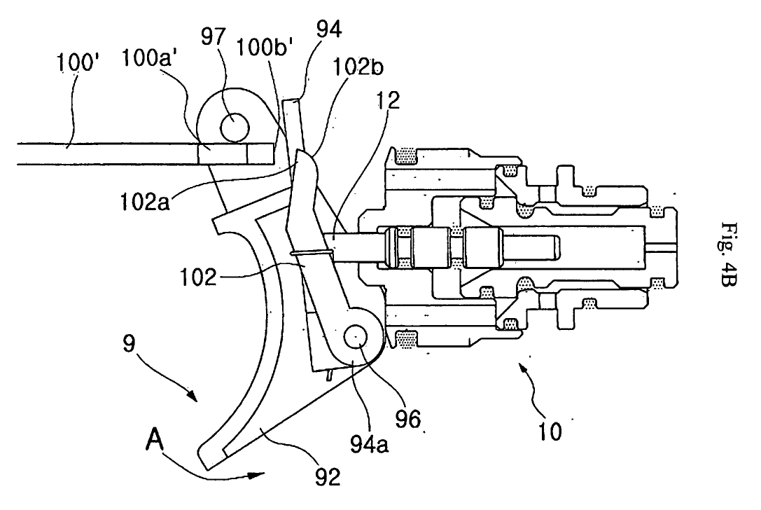

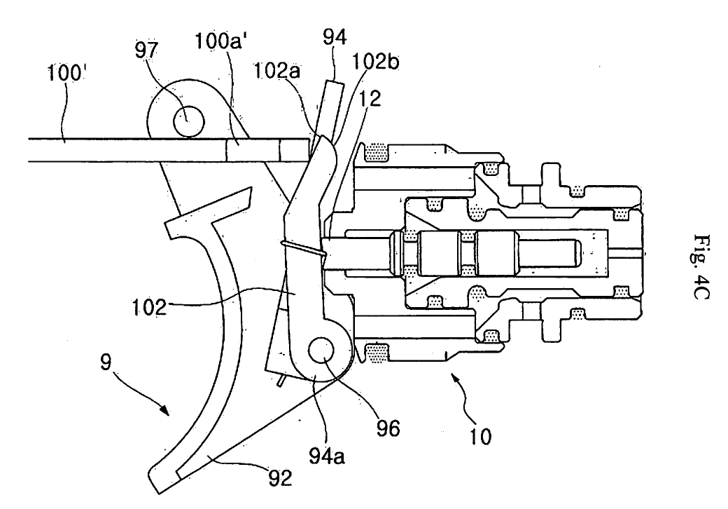

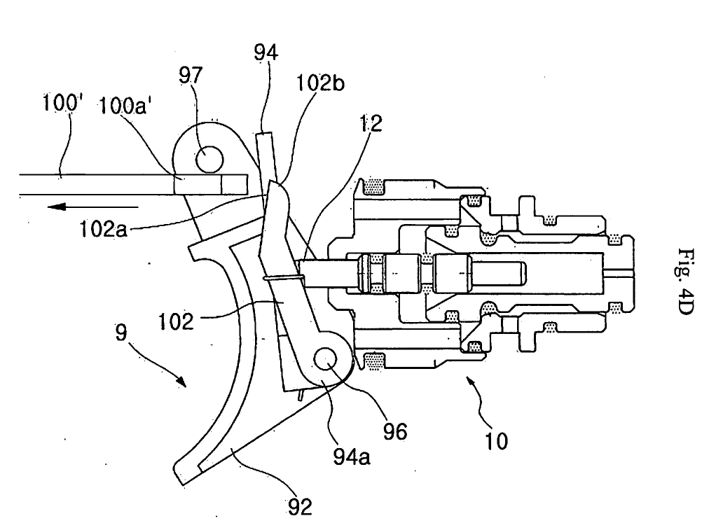

FIGS. 4A, 4B, 4C, and 4D are transversal views illustrating the constitution and operation of the anti-double firing means in a continuous firing mode using the tacker with the anti-double firing means in accordance with the embodiment of the present invention.

In the continuous firing mode using the tacker with the anti-double firing means in accordance with the embodiment of the present invention, the anti-double firing plate 102 must not disturb the movement of the connector 100′. That is, when the connector 100′ moves, the anti-double firing plate 102 must not disturb the movement of the connector 100′.

In the continuous firing mode, when a user pulls the trigger 92 in the direction of A in the initial state as shown in FIG. 4A, the pushing plate 94 contacts the valve rod 12 as shown in FIG. 4B. Then, the front end of the tacker is pressed against a target site of an object, thereby moving the connector 100′ toward the operating member 10 (in the direction of B) and causing the connector 100′ to press the valve rod 12 to fire a nail into the target site. When the tacker is switched from the single firing mode to the continuous firing mode, the anti-double firing plate 102 is laid on the side surface of the pushing plate 94, thus not disturbing the movement of the connector 100′.

The trigger 92 has been pulled in the direction of A after firing, and, when the tacker is separated from the target site, the connector 100′ moves forward as shown in FIG. 4D.

If the number of target sites of an object is three and the target sites are in close proximity, the user pulls the trigger 92 in the continuous firing mode, and presses the connector 100′ against one target site of the object, thereby causing one nail to be launched toward the first target site of the object. Then, the user moves the tacker under the condition that the trigger 92 is pulled, and presses the connector 100′ against another target site of the object, thereby causing other nails to be continuously launched toward the second and third target sites of the object. Since the anti-double firing plate 102 is located on the side surface of the pushing plate 94, the anti-double firing plate 102 does not disturb the movement of the connector 100′, thus allowing the tacker to precisely perform a continuous firing operation.

As apparent from the above description, the present invention provides a tacker with anti-double firing means for use in a single firing mode, which restrains double firing of nails caused by the repulsive force of a connector to prevent arbitrary firing of nails caused by the repulsive force, thereby precisely performing a single firing operation.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A tacker with anti-double firing means, the tacker which has a body, a guide installed at the front end of the body, a cover installed at the rear end of the body and provided with a member for controlling compressed air, a handle grip and a trigger installed at the lower end of the body, a magazine installed under the guide and filled with tacker pins, and a pushing plate installed in the trigger for pressing a valve rod for operating a piston, the anti-double firing means comprising:
a connector installed in the guide installed at the front end of the body of the tacker such that the connector moves back and forth, and provided with a notch formed in a designated portion of the rear end thereof such that the upper end of an anti-double firing plate is inserted into the notch in a single firing mode; and
the anti-double firing plate separated from the pushing plate by a designated distance, coaxially connected to the pushing plate by a connection pin, and restraining the connector from moving backward due to the repulsive force of the connector.

2. The tacker as set forth in claim 1, wherein a fixing spring connected to the connection pin is fixed to one side of the anti-double firing plate to cause the upper end of the anti-double firing plate to be located close to an operating member.

3. The tacker as set forth in claim 1, wherein a latched plane for preventing the connector from moving backward due to the repulsive force is formed on the front surface of the anti-double firing plate, and a rounded plane for allowing the connector to move toward the front end of the tacker is formed on the rear surface of the anti-double firing plate.
